(19) United States
(12) Patent Application Publication
(10) Pub. No.: US 2024/0258800 A1
(43) Pub. Date: Aug. 1, 2024

(54) POWER SUPPLY SYSTEM

(71) Applicant: TOYOTA JIDOSHA KABUSHIKI KAISHA, Toyota-shi (JP)

(72) Inventors: Yasuhiro ENDO, Toyota-shi (JP); Junta IZUMI, Nagoya-shi (JP); Hironori MIKI, Nagoya-shi (JP); Kenji KIMURA, Nagoya-shi (JP); Takayuki BAN, Nishio-shi (JP); Takuya MIZUNO, Nagakute-shi (JP); Shuji TOMURA, Nagakute-shi (JP); Naoki YANAGIZAWA, Nagakute-shi (JP); Kazuo OOTSUKA, Nagakute-shi (JP); Hiroshi TSUKADA, Nagakute-shi (JP)

(73) Assignee: TOYOTA JIDOSHA KABUSHIKI KAISHA, Toyota-shi (JP)

(21) Appl. No.: 18/419,886

(22) Filed: Jan. 23, 2024

(30) Foreign Application Priority Data
Jan. 30, 2023 (JP) 2023-011868

(51) Int. Cl. H02J 7/00

(52) U.S. Cl. CPC H02J 7/0013

(57) ABSTRACT

The alternating current sweep unit outputs alternating current power from three battery strings that are Y-connected. The offset voltage command Vst_offset is calculated by adding the offset component V*abc_off of the string voltage obtained from the string voltage command V*abc, the amplitude Vamp of the command voltage calculated using dq shaft voltage command values v*d and v*q, and the margin voltage Vmrg. By determining the on-time ton of the gate signal by using the string voltage command V*abc and the offset voltage command Vst_offset and performing duty control on the gate signal, it is possible to set an offset voltage corresponding to the command voltage, and thus it is possible to suppress an increase in battery loss.

### CROSS-REFERENCE TO RELATED APPLICATION

This application claims priority to Japanese Patent Application No. 2023-011868 filed on Jan. 30, 2023, incorporated herein by reference in its entirety.

### BACKGROUND

### 1. Technical Field

The present disclosure relates to a power supply system.

### 2. Description of Related Art

Japanese Unexamined Patent Application Publication No. 2022-120255 (JP 2022-120255A) discloses a power supply system that outputs alternating current (AC) power (AC voltage) using a battery string in which a plurality of battery circuit modules can be connected in series. The battery circuit module included in the battery string includes a battery, a first switch connected in parallel to the battery, a second switch connected in series to the battery, and a first output terminal and a second output terminal to which a voltage of the battery is applied when the first switch is in an OFF state and the second switch is in an ON state. By controlling the first switch and the second switch of each battery circuit module included in the battery string, the output voltage of the battery string can be adjusted to a desired magnitude.

Since the battery string can output only a voltage of 0 [V] or more, the power supply system can output the alternating current power by outputting, from a plurality of the battery strings, a voltage of a sine wave centered on an offset voltage with a phase difference.

### SUMMARY

When the voltage of the alternating current power output from the power supply system is the same, and the offset voltage is set high, the voltage output from the battery string increases. When the voltage output from the battery string increases, the duty ratio for driving a first switch and a second switch of the battery circuit module increases, so that the current effective value of the battery string (battery) increases. When the current effective value increases, an increase in battery loss, a deterioration in efficiency of the power supply system, and the like occur.

An object of the present disclosure is to suppress an increase in battery loss in a power supply system that outputs alternating current power using a battery string.
(1) A power supply system according to the present disclosure includes: an alternating current sweep unit for outputting alternating current power from a first battery string, a second battery string, and a third battery string that have been Y-connected; and a control device for controlling the alternating current sweep unit. Each of the first battery string, the second battery string, and the third battery string includes a plurality of battery circuit modules connected in series. The battery circuit module includes a battery, a first switch connected in parallel to the battery, a second switch connected in series to the battery, and a first output terminal and a second output terminal to which a voltage of the battery is applied when the first switch is in an OFF state and the second switch is in an ON state. The control device is configured to set an offset voltage of an alternating current voltage output from each of the first battery string, the second battery string, and the third battery string based on a command voltage of the first battery string, the second battery string, and the third battery string.

According to this configuration, a duty ratio for turning ON and OFF the first switch and the second switch of the battery circuit module is controlled, so that an output voltage of the battery strings is controlled. Each of the battery strings that have been Y-connected outputs a voltage of a sine wave centered on the offset voltage, and the alternating current power is output from the alternating current sweep unit. The voltage of a sine wave is a waveform obtained by adding the offset voltage to the alternating current voltage, and this voltage is also referred to as the alternating current voltage in the present disclosure.

The control device sets the offset voltage of the alternating current voltage output from each battery string based on a command voltage of each battery string. Accordingly, the offset voltage can be set in accordance with the command voltage, and a suitable duty ratio can be used, so that an increase in battery loss can be suppressed.
(2) Preferably, the control device may set the offset voltage based on an amplitude of the command voltage.

According to this configuration, since the offset voltage is set in accordance with the amplitude of the command voltage of each battery string, it is possible to set the minimum necessary offset voltage.
(3) In the above (2), the control device may control the alternating current sweep unit such that an alternating current voltage having a phase difference by 120° from each of the first battery string, the second battery string, and the third battery string is output, and may set the offset voltage based on an offset component of the command voltage of the first battery string, the second battery string, and the third battery string.

According to this configuration, three-phase alternating current power is output from the alternating current sweep unit. When the output three-phase alternating current voltage is balanced (balanced three-phase alternating current), the added value of the command voltages of the respective battery strings becomes zero, and the offset component becomes zero. When the three-phase alternating current voltage is unbalanced (unbalanced three-phase alternating current), the offset voltage is set by adding, to the amplitude of the command voltage of each phase battery string, the offset component obtained by multiplying the sum of the command voltages of the first battery string, the second battery string, and the third battery string by one third. This makes it possible to appropriately set the offset voltage even in the unbalanced three-phase alternating current.
(4) In the above (1) to (3), the control device may set the offset voltage based on a minimum voltage output from each of the first battery string, the second battery string, and the third battery string.

In some cases, the minimum voltage of the output power of the battery string is set such that the output voltage of the battery string does not become unstable. According to this configuration, since the offset voltage is set in accordance with the minimum voltage output from each battery string, the alternating current power can be stably output from the alternating current sweep unit.

According to the present disclosure, it is possible to suppress an increase in battery loss in a power supply system that outputs alternating current power using a battery string.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a power supply system according to an embodiment of the present disclosure;

FIG. 2 is a diagram illustrating a configuration of a battery string;

FIG. 3A is a schematic diagram illustrating operation of a battery circuit module controlled by a gate-signal;

FIG. 3B is a schematic diagram illustrating operation of a battery circuit module controlled by a gate-signal;

FIG. 3C is a schematic diagram illustrating operation of a battery circuit module controlled by a gate-signal;

FIG. 3D is a schematic diagram illustrating operation of a battery circuit module controlled by a gate-signal;

FIG. 4 is a functional block diagram of a power supply system used for grid interconnection;

FIG. 5 is a block-diagram for calculating an offset voltage; and

FIG. 6 is a flowchart illustrating a process of alternating current sweep control executed by the control device.

### DETAILED DESCRIPTION OF EMBODIMENTS

An embodiment of the present disclosure will be described in detail with reference to the drawings. In the drawings, the same or corresponding parts are denoted by the same reference signs and the description thereof will not be repeated.

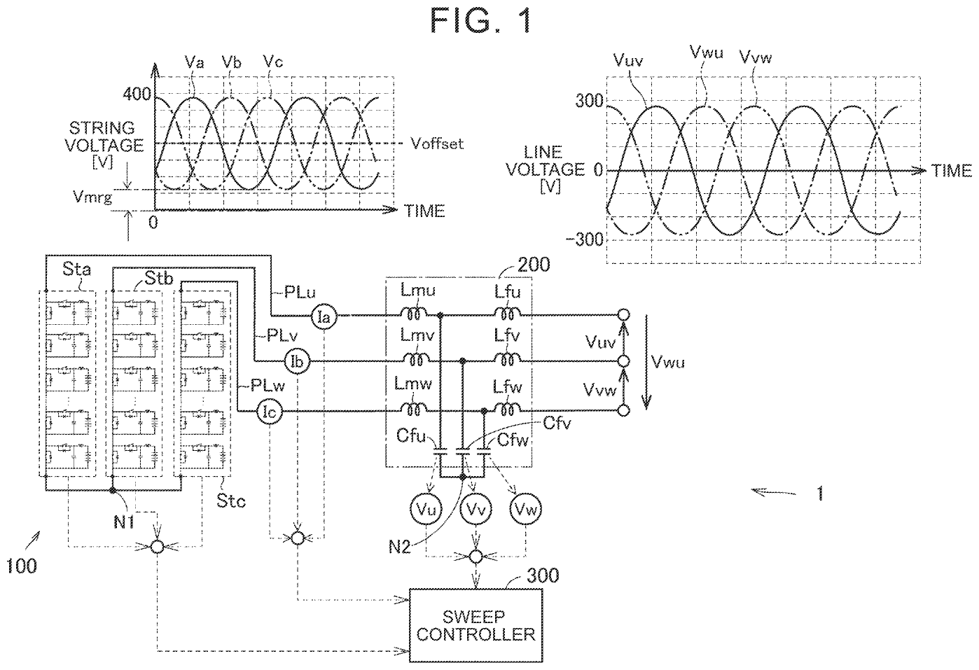

FIG. 1 is a diagram illustrating a configuration of a power supply system according to an embodiment of the present disclosure. Referring to FIG. 1, the power supply system 1 includes an alternating current sweep unit 100, an LCL filter 200, and a control device (sweep controller) 300. The control device 300 may be a computer, and includes, for example, a processor, a storage device, and a communication I/F (interface). The storage device stores, for example, a program executed by the processor and information (for example, a map, a mathematical expression, and various parameters) used in the program.

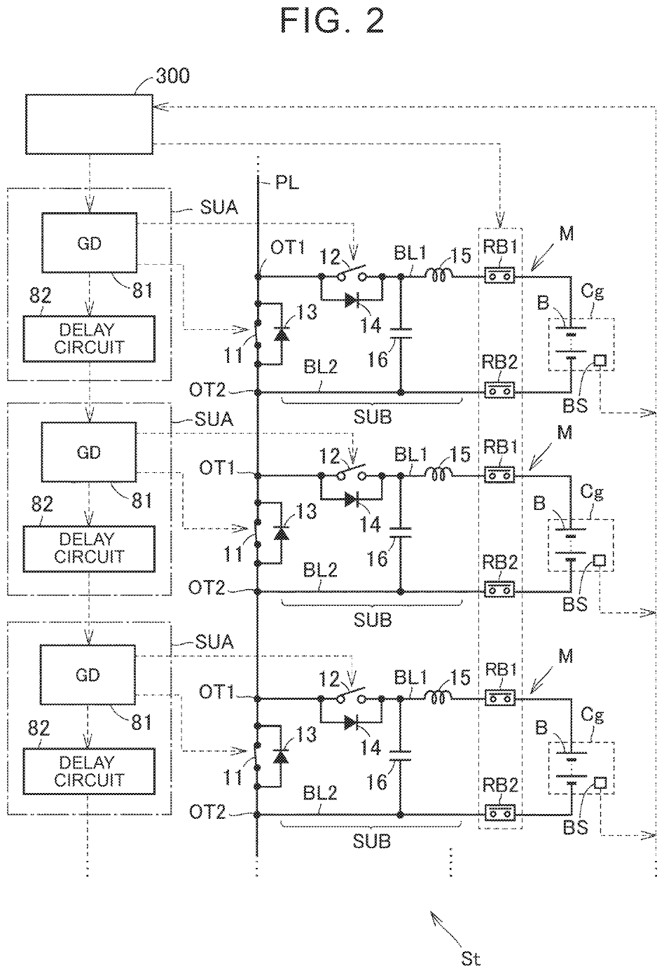

The alternating current sweep unit 100 comprises three battery strings Sta, Stb, Stc. The negative terminal of each of the battery strings Sta-Stc is connected to the neutral point N1. The battery string Sta, Stb, Stc according to this embodiment corresponds to an exemplary “first battery string”, “second battery string”, and “third battery string” according to the present disclosure. Since the configuration of the battery string Sta-Stc is substantially the same, these configurations will be described with reference to FIG. 2. In the following, when the battery string Sta-Stc is not distinguished, the battery string Sta-Stc is referred to as “battery string St”.

FIG. 2 is a diagram illustrating a configuration of a battery string St. The battery string St includes a plurality of battery circuit modules M. In the present embodiment, the number of the battery circuit modules M included in the battery string St is 14, but the number thereof is optional and may be 5 to 50, or may be 100 or more. In the present embodiment, the battery string St includes the same number of battery circuit modules M, but the number of battery circuit modules M may be different for each battery string St.

Each of the battery circuit modules M includes a power circuit SUB and a cartridge Cg. The cartridge Cg includes a battery B and a monitoring unit BS. The power circuit SUB and the battery B are connected to each other to form a battery circuit module M including the battery B. The drive circuit SUA is configured to drive switches (a SW11 and a SW12 described later) included in the battery circuit module M. The battery B may be a nickel-hydrogen secondary battery or a lithium-ion secondary battery, and the battery B 20 may be manufactured by connecting the secondary batteries used in electrified vehicle in series.

As shown in FIG. 2, the battery circuit module M includes a power circuit SUB, a cartridge Cg, and circuit breakers RB1 and RB2 (hereinafter referred to as “circuit breaker RB” unless otherwise distinguished). The power circuit SUB and the cartridge Cg are connected to each other via a circuit breaker RB1 and a RB2. The breaker RB switches between the power circuit SUB and the cartridge Cg (conduction/disconnection) according to a command from the control device 300. The breaker RB may be configured for manual ON/OFF by a user, with the configuration allowing the cartridge Cg to be detachably attached to the power circuit SUB.

In the cartridge Cg, the monitoring unit BS is configured to detect the status of the battery B (e.g., voltage, current, and temperature) and to provide the detected data to the control device 300.

The battery circuit modules M included in the battery string St are connected by a common electric wire PL. The electric wire PL includes the output terminals OT1 and OT2 of the respective battery circuit modules M. The output terminal OT2 of the battery circuit is connected to the output terminal OT1 of the battery circuit adjoining the battery circuit module M, thereby connecting the battery circuit modules M included in the battery string St.

The power circuit SUB includes a first switching element 11 (hereinafter referred to as “SW11”), a second switching element 12 (hereinafter referred to as “SW12”), a first diode 13, a second diode 14, a choke coil 15, a capacitor 16, and output terminals OT1 and OT2. Each of SW11 and SW12 is driven by the drive circuit SUA. SW11, SW12 according to the present embodiment corresponds to exemplary “first switch” and “second switch”, respectively.

A SW11, a capacitor 16, and a battery B are connected in parallel between an output terminal OT1 and a OT2 of the power circuit SUB. SW11 is located on the electric wire PL and is configured to switch between an output terminal OT1 and an output terminal OT2. The output terminal OT1 is connected to the positive electrode of the battery B via the electric wire BL1, and the output terminal OT2 is connected to the negative electrode of the battery B via the electric wire BL2. The electric wire BL1 is further provided with a SW12 and a choke coil 15. In the battery circuit BC, when SW12 connected in series with the battery B is in ON state (connected state) and SW11 connected in parallel with the battery B is in OFF state (cut-off state), the voltage of the battery B is applied between the output terminal OT1 and OT2.

A capacitor 16 connected to each of the electric wire BL1 and the electric wire BL2 is provided between the output terminal OT1,OT2 and the battery B. Each of SW11 and SW12 is, for example, a FET (field-effect transistor). The first diode 13 and the second diode 14 are connected in parallel to SW11, SW12. Note that each of SW11 and SW12 is not limited to FET, and may be a switch other than FET.

The control device 300 generates a gate signal. The drive circuit SUA is provided for each battery circuit module M, and includes a GD (gate driver) 81 that drives SW11 and SW12 according to the gate signal, and a delay circuit 82 that delays the gate signal. Each of SW11 and SW12 included in the battery circuit module M is ON/OFF controlled in accordance with the gate signal.

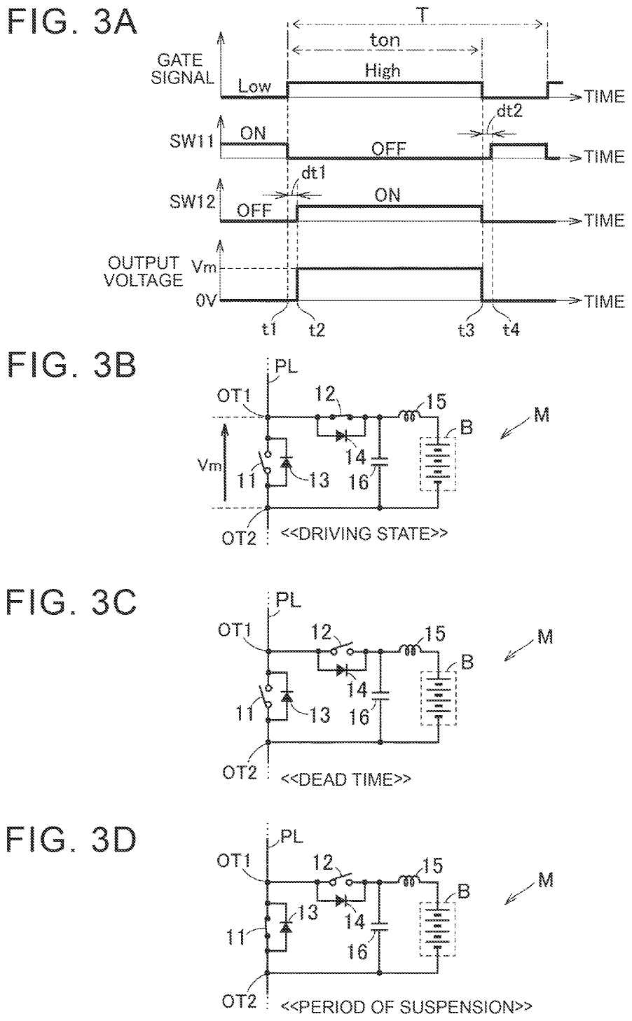

FIGS. 3A to 3D are a diagram for explaining the operation of the battery circuit module M controlled by the gate signal. FIG. 3A is a diagram illustrating an exemplary operation of a battery circuit module M, and in the present embodiment, a square-wave signal is adopted as a gating signal for driving a SW11 and a SW12. The “Low” and “High” of the gate signal shown in FIG. 3A refer to the L level and the H level of the gate signal (rectangular wave signal), respectively. The “output voltage” means a voltage output between the output terminals OT1 and OT2. In the initial state of the battery circuit module M, the gate signal is not inputted to the drive circuit SUA (gate signal=L level), and SW11, SW12 are in ON state and OFF state, respectively. In the present embodiment, a rectangular wave signal is adopted as a gate signal for driving the battery circuit module M. SW11 and SW12 are switched in ON/OFF according to the rising/falling edge of the gate-signal. The control device 300 performs PWM (pulse-width-modulation) control using a gate-signal.

When a gate signal is input to the drive circuit SUA, GD31 drives SW11 and SW12 in accordance with the input gate signal. In the embodiment shown in FIGS. 3A to 3D, the gate signal rises from the L level to the H level at the timing t1, and SW11 is switched from ON state to OFF state at the same time as the rising of the gate signal. Then, SW12 is switched from OFF state to ON state at a timing t2 delayed by a predetermined time (dead time dt1) from the rising edge of the gate-signal. As a result, the battery circuit module M is in the driving state, and as shown in FIG. 3B, SW11 is in OFF state and SW12 is in ON state, so that the voltage of the battery B is applied between the output terminal OT1 and OT2.

Referring to FIG. 3A, when the gate signal falls from the H level to the L level at the timing t3, SW12 is switched from ON state to OFF state at the same time as the falling of the gate signal. As a result, the battery circuit module M is stopped. In the battery circuit module M in the stopped state, SW12 is turned OFF, so that the voltage of the battery B is not applied between the output terminal OT1 and OT2. Thereafter, SW11 is switched from OFF state to ON state at a timing t4 delayed by a predetermined time (referred to as a dead time dt2) from the falling edge of the gate-signal. The dead time dt1 and the dead time dt2 may be the same as or different from each other.

In the dead time dt1, dt2, both SW11 and SW12 are turned OFF as shown in FIG. 3C. As a result, SW11 and SW12 are suppressed from being turned ON at the same time (the battery circuit module M is short-circuited).

When the period from the end (t4) of the dead time dt2 until the battery circuit module M becomes the driving state is referred to as the “stopping period”, in the stopping period, SW11 is in ON state and SW12 is in OFF state as in the initial state, as shown in FIG. 3D.

The gate signal is delayed by a predetermined delay time Td by the delay circuit 82, and is transmitted from the upstream drive circuit SUA to the downstream drive circuit SUA. In the present embodiment, the number of the battery circuit modules M is 14, and the cycle T of the gate signal is Td×14, and the number of the battery circuit modules M in the driving status can be adjusted by controlling the duty cycle (time of H level: on-time ton).

By controlling the battery circuit module M included in the battery string St as described above, the number of the battery circuit modules M in the drive state can be adjusted, and the output-voltage of the battery string St can be controlled. Accordingly, the battery string St is capable of outputting a voltage from 0V to the sum of the voltages of the batteries B (cartridge Cg) included in the battery string St.

Referring back to FIG. 1, the positive terminal of the first battery string Sta is connected to the power line PLu. The positive electrode terminal of the second battery string Stb is connected to the power line PLv, and the positive electrode terminal of the third battery string Stc is connected to the power line PLw. The negative terminal of each battery string Sta-Stc is connected to the neutral point N1, and is Y-connected so that the output-voltage polarity of each battery string Sta-Stc becomes the same at the neutral point.

According to a control command from the control device 300, the string voltage (output voltage) of the battery string Sta-Stc is controlled to be the voltage waveform shown in the upper left of FIG. 1. In FIG. 1, the line Va is the string voltage “Va” of the first battery string Sta, the line Vb is the string voltage “Vb” of the second battery string Stb, and the line Vc is the string voltage “Vc” of the third battery string Stc. The respective voltages Va, Vb, Vc are sinusoidal waves centered on the offset voltage Voffset and are 120° out of phase with each other.

As described above, by controlling the voltage Vc from the string voltages Va of the respective battery strings Sta-Stc, the line voltages of the power lines PLu, PLv and PLw become the voltage waveforms shown in the upper right of FIG. 1. The line Vuv indicates the line voltage “Vuv” between the power line PLu and the power line PLv, the line Vwu indicates the line voltage “Vwu” between the power line PLw and the power line PLu, and the line Vvw indicates the line voltage “Vvw” between the power line PLv and the power line Plw. Each line voltage becomes a sinusoidal alternating current waveform whose polarity (positive/negative) changes periodically. Accordingly, alternating current power (three-phase alternating current power) is output from the alternating current sweep unit 100.

In FIG. 1, LCL filter 200 includes an interconnection reactor Lmu, Lmv, Lmw, a filter capacitor Cfu, Cfv, Cfw, and a filter reactor Lfu, Lfv, Lfw, which are provided for the power lines PLu, PLv and PLw, respectively. One end of each of the filter capacitor Cfu, Cfv and Cfw is connected to the neutral point N2. Each of the filter capacitors Cfu, Cfv, Cfw is provided with a voltage sensor Vu, Vv, Vw, and is configured to detect a voltage of the filter capacitor Cfu, Cfv, Cfw and to provide a detected value to the control device 300.

Further, a current sensor Ia for detecting an output current Ia of the first battery string Sta, a current sensor Ib for detecting an output current Ib of the second battery string Stb, and a current sensor Ic for detecting an output current Ic of the third battery string Stc are provided, and the detected values are inputted to the control device 300. LCL filters 200 may be connected to the home or the power system via a distribution board.

In the alternating current sweep unit 100 configured as described above, when the offset voltage Voffset of the string voltage is high, even when the voltage of the line voltage Vuv-Vwu (the voltage of the alternating current power) is the same, the string voltage Va-Vc needs to be high. The string voltage Va-Vc is determined by “PWM control duty cycle (%)×(cartridge voltage×number of cartridges)”. Therefore, when the offset voltage Voffset is set high, the duty cycle increases. When the duty ratio increases, the current effective value of the electric power output from the battery B increases. When the current effective value increases, the loss of the battery B increases, and the efficiency of the power supply system 1 (alternating current sweep unit 100) deteriorates. In the present embodiment, the offset voltage Voffset is set appropriately to suppress the loss of the battery B.

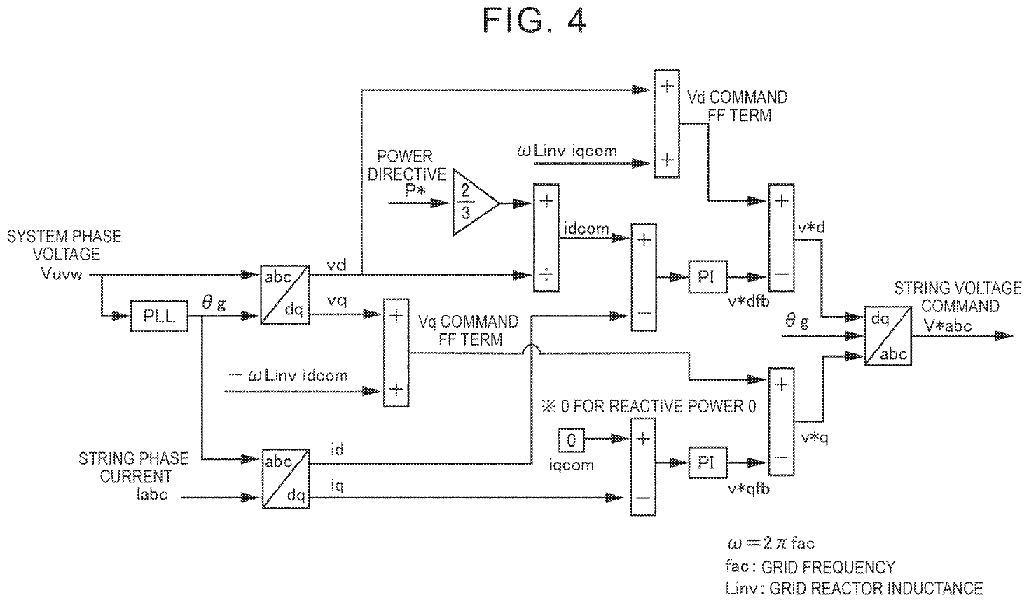

FIG. 4 is a block diagram showing a case where the power supply system 1 is used for system interconnection. The control device 300 calculates a voltage command V*abc of the battery string St. Since the block diagram of FIG. 4 is substantially the same as the block diagram disclosed in JP 2022-120255 A, a brief description will be given.

First, the phase θg of the system voltage is calculated by PLL (Phase Lock Loop) from the system phase voltage Vu, Vv, Vw detected by the voltage sensor of the filter capacitor Cfu, Cfv, Cfw of LCL filter 200. Next, abc/dq is converted by the voltage phase θg and the system phase voltage Vu, Vv, Vw, and dq shaft voltage vd, vq is calculated. Further, the output current Ia, Ib, Ic of the battery string St is abc/dq converted, and dq shaft current id, iq is calculated. Next, the d-axis command current idcom is calculated from the power command P* and the d-axis voltage vd for the power supply system 1. When the reactive power is set to zero (0), the q-axis command current iqcom is set to 0.

Dq axis command voltage-feedback (FB) term v*dfb and v*qfb are calculated by PI control using dq axis command current idcom, iqcom and dq axis current id, iq. A vd command feedforward (FF) term and a vq command FF term are added to these dq axis command voltage FB terms to obtain a d-axis voltage command value v*d and a q-axis voltage command value v*q. Then, dq shaft voltage command values v*d and v*q are dq/abc converted to a three-phase abc shaft from dq shaft, and the voltage command V*abc of the battery string St (the voltage command V*a of the first battery string Sta, the voltage command V*b of the second battery string Stb, the voltage command V*c of the third battery string) is calculated. Note that the voltage command V*abc of the battery string St corresponds to an exemplary “command voltage” disclosed herein.

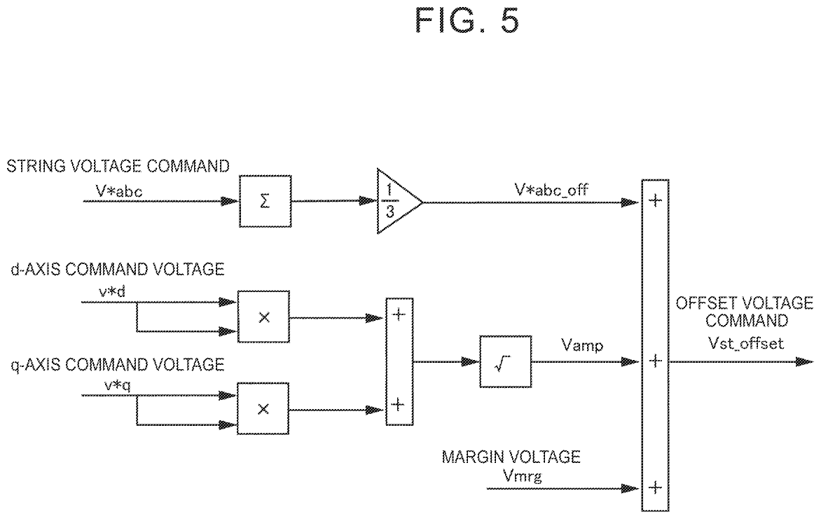

FIG. 5 is a diagram for calculating an offset voltage Voffset. The control device 300 calculates an offset voltage command Vst_offset of the battery string St. First, the offset component V*abc_off of the string voltage command V*abc is calculated by multiplying the sum of the string voltage command V*abc (the voltage command V*a of the first battery string Sta, the voltage command V*b of the second battery string Stb, and the voltage command V*c of the third battery string) calculated in the block diagram of FIG. 4 by ⅓. When the string voltage command V*abc is a balanced three-phase alternating current (three-phase balanced voltage), the offset-component V*abc_off becomes zero (0).

The square value of the d-axis voltage command value v*d and the square value of the q-axis voltage command value v*q are added by using dq axis voltage command values v*d and v*q calculated in the block diagram of FIG. 4, and the square root of the added value is calculated as the magnitude Vamp of the command voltage (voltage command V*abc). The offset voltage command Vst_offset is calculated by adding the offset components V*abc_off, the magnitude Vamp of the command voltage, and the margin voltage Vmrg. The margin voltage Vmrg is the lowest voltage that can be output from the battery string St, and may be, for example, the output voltage of the cartridge Cg. In the present embodiment, all the batteries B of the cartridge Cg included in the battery string St have the same specifications, and the voltage of the cartridge Cg (battery B) is, for example, 44.4[V] The margin Vmrg is 44.4[V] is set.

The control device 300 uses the string voltage command V*abc and the offset voltage command Vst_offset to calculate the on-time ton of the gate signal from

$$\begin{matrix}Equation ( 1 ) . & \\ ton = ( V * abc + V st\_offset ) \times ( td / V bave\_abc ) & ( 1 )\end{matrix}$$

Note that Vbave_abc is the mean voltage of each battery circuit module M of the battery string Sta-Stc.

When the duty cycle of the gate signal in each of the battery strings Sta-Stc is controlled so that the on-time ton calculated by Equation (1) is achieved, the offset voltage Voffset of the alternating current voltage outputted from each of the battery strings Sta-Stc becomes a voltage corresponding to the offset voltage command Vst_offset.

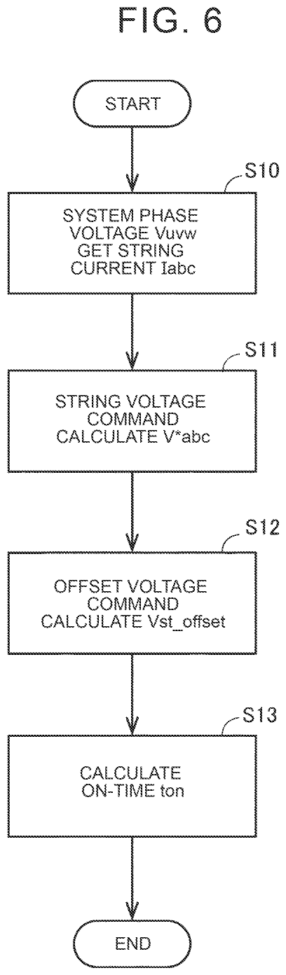

FIG. 6 is a flowchart showing a process of alternating current sweep control executed by the control device 300. This flowchart is repeatedly processed at predetermined time intervals during operation of the power supply system 1. First, in step (hereinafter, step is abbreviated as “S”) 10, the system phase voltage Vu, Vv, Vw (Vuvw) detected by the voltage sensor of the filter capacitor Cfu, Cfv, Cfw of LCL filter 200 and the output current Ia, Ib, Ic (Iabc) of the battery string St detected by the current sensor Ia-Ic are acquired. In the following S11, as described in the block-diagram of FIG. 4, after the string-voltage command V*abc is calculated, the process proceeds to S12. In S12, the offset voltage command Vst_offset is calculated using the block-diagram of FIG. 5. In the following S13, the on-time ton of the gate-signal is calculated using Expression (1), and the present routine is ended.

According to the present embodiment, the offset voltage Voffset of the alternating current voltage outputted from each of the battery strings Sta-Stc is set based on the voltage command V*abc of the battery string Sta-Stc. As a result, the offset voltage Voffset can be set according to the voltage command V*abc, and a suitable duty cycle can be used, so that it is possible to suppress an increase in the loss of the battery B.

In the above-described embodiment, in the block-diagram of FIG. 5, the offset-component V*abc_off of the string-voltage command V*abc is calculated. However, when the string voltage command V*abc is a balanced three-phase alternating current (three-phase balanced voltage), it is not necessary to calculate the offset-component V*abc_off.

In the above-described embodiment, the margin voltage Vmrg is added to the offset voltage command Vst_offset, but the offset voltage command Vst_offset may be calculated without using the margin voltage Vmrg when the minimum voltage that can be outputted from the battery string St is not set.

In the above embodiment, the alternating current sweep unit 100 is composed of three battery strings Sta, Stb, Stc, but each of the battery strings Sta-Stc may be composed of a plurality of battery strings connected in parallel.

The embodiments disclosed herein should be considered to be exemplary and not restrictive in all respects. The scope of the present disclosure is shown by the scope of claims rather than the description of the embodiments above, and is intended to include all modifications within the meaning and the scope equivalent to the scope of claims.

What is claimed is:

1. A power supply system comprising:
an alternating current sweep unit for outputting alternating current power from a first battery string, a second battery string, and a third battery string that have been Y-connected; and
a control device for controlling the alternating current sweep unit, wherein:
each of the first battery string, the second battery string, and the third battery string includes a plurality of battery circuit modules connected in series;
each of the battery circuit modules includes a battery, a first switch connected in parallel to the battery, a second switch connected in series to the battery, and a first output terminal and a second output terminal to which a voltage of the battery is applied when the first switch is in an OFF state and the second switch is in an ON state; and
the control device is configured to set an offset voltage of an alternating current voltage output from each of the first battery string, the second battery string, and the third battery string based on a command voltage of the first battery string, the second battery string, and the third battery string.

2. The power supply system according to claim 1, wherein the control device sets the offset voltage based on an amplitude of the command voltage.

3. The power supply system according to claim 2, wherein the control device
controls the alternating current sweep unit such that an alternating current voltage having a phase difference by 120° from each of the first battery string, the second battery string, and the third battery string is output, and
sets the offset voltage based on an offset component of the command voltage of the first battery string, the second battery string, and the third battery string.

4. The power supply system according to claim 1, wherein the control device sets the offset voltage based on a minimum voltage output from each of the first battery string, the second battery string, and the third battery string.
